(19) United States
(12) Patent Application Publication
(10) Pub. No.: US 2025/0350641 A1
(43) Pub. Date: Nov. 13, 2025

(54) METHODS AND APPARATUS FOR A SIXTH GENERATION (6G) ROAMING SOLUTION USING PROTOCOL FOR N32 INTERCONNECT SECURITY (PRINS) WITH ROAMING INTERMEDIARIES

(71) Applicant: CABLE TELEVISION LABORATORIES, INC., Louisville, CO (US)

(72) Inventor: Tao Wan, Ottawa (CA)

(21) Appl. No.: 19/203,639

(22) Filed: May 9, 2025

Related U.S. Application Data
(60) Provisional application No. 63/644,961, filed on May 9, 2024.

(51) Int. Cl. H04L 9/40; H04L 9/32; H04L 61/4511; H04W 84/04

(52) U.S. Cl. CPC H04L 63/166; H04L 9/3247; H04L 61/4511; H04W 84/042

(57) ABSTRACT

Session management for a Fifth Generation (5G) roaming solution using PRotocol for N32 INterconnect Security (PRINS) with roaming intermediaries is described herein. A first network node establishes a transport layer security (TLS) connection with a second network node, wherein the TLS connection is established using hypertext transfer protocol secure (HTTPS) as a uniform resource identifier (URI). The first network node creates a security negotiation request message, including a fully qualified domain name (FQDN) of the second network node. The first network node protects information elements (IEs) in the security negotiation request message with a Javascript Object Notation (JSON) Web Signature (JWS) token, wherein the JWS token uses a digital signature and includes a public key certificate of the first network node. The first network node sends over TLS, to the second network node, an HTTPS request, including the security negotiation request message and the JWS token.

### CROSS-REFERENCE TO RELATED APPLICATIONS

This application claims the benefit of U.S. Provisional Application No. 63/644,961, filed May 9, 2024, the contents of which are incorporated herein by reference.

### BACKGROUND

In Third Generation Partnership Project (3GPP) communication, service based interfaces (SBIs) include protection at the network layer or transport layer. Accordingly, network functions support the mutually authenticated transport layer security (TLS) protocol and hypertext transfer protocol secure (HTTPS). The identities in the end entity certificates are used for authentication and policy checks. Network functions shall support both server-side and client-side certificates. TLS is used for transport protection within a public land mobile network (PLMN) unless security is provided by other means. Further, TLS may be used for protection between a network function and a Security Edge Protection Proxy (SEPP).

PRotocol for N32 INterconnect Security (PRINS) is an application layer security protocol for the roaming interface N32 to provide end-to-end message protection between a Visiting PLMN Security Edge Protection Proxy (vSEPP) and home PLMN SEPP (hSEPP). PRINS is based on the security requirements and design principles for application layer security provided to 3GPP by the Global System for Mobile communications Association (GSMA), including diameter end-to-end subgroup (DESS) requirements. PRINS satisfies the end-to-end security requirements from GSMA, which is an important security improvement in Fifth Generation (5G) roaming over Fourth (4G) roaming.

The 5G roaming interface, N32, consists of N32-f, an interface for forwarding signaling messages between network functions in the two PLMNs, and N32-c, a control interface for managing N32-f, including negotiating security protection related parameters for N32-f/PRINS.

In PRINS, N32-c is an HTTP/2 connection within an end-to-end TLS tunnel between vSEPP and hSEPP. This end-to-end N32-c TLS tunnel is established over roaming intermediaries (RIs) via HTTP CONNECT, which turns RI HTTP proxies into transmission control protocol (TCP) proxies, allowing TCP payloads carrying TLS messages to be exchanged directly between vSEPP and hSEPP.

### SUMMARY

Methods and apparatus for session management for a Fifth Generation (5G) roaming solution using PRotocol for N32 INterconnect Security (PRINS) with roaming intermediaries are provided herein. In an example, a first network node establishes a transport layer security (TLS) connection with a second network node. The TLS connection is established using hypertext transfer protocol secure (HTTPS) as a uniform resource identifier (URI).

The first network node creates a security negotiation request message, including a fully qualified domain name (FQDN) of the second network node. Further, the first network node protects one or more information elements (IEs) in the security negotiation request message with a first Javascript Object Notation (JSON) Web Signature (JWS) token. The first JWS token uses a first digital signature and includes a public key certificate of the first network node. Moreover, the first network node sends over TLS, to the second network node, a first HTTPS request, including the security negotiation request message and the first JWS token.

Additionally or alternatively, the second network node receives receive, from the first network node, the first HTTPS request, including the security negotiation request message and the first JWS token. Further, the second network node determines to allow an N32 connection negotiation based on checking the security negotiation request message against the security and contractual policies of the second network node. Also, the second network node appends, based on the determination to allow the N32 connection negotiation, a public land mobile network (PLMN) identity (ID) of the first network node, an FQDN of the second network node, and an FQDN of a third network node as a second JWS token to the security negotiation request message. Moreover, the second network node sends over TLS, to the third network node, a second HTTPS request, including the security negotiation request message, the first JWS token and the second JWS token.

Additionally or alternatively, the third network node receives from the second network node, the second HTTPS request, including the security negotiation request message, the first JWS token and the second JWS token. The third network node determines to allow an N32 connection negotiation based on checking the security negotiation request message against the security and contractual policies of the third network node. Further, the third network node appends, based on the determination to allow the N32 connection negotiation, an FQDN of the second network node, the FQDN of the third network node, and a PLMN ID of a fourth network node, as a third JWS token to the security negotiation request message. Moreover, the third network node sends over TLS, to the fourth network node, a third HTTPS request, including the security negotiation request message, the first JWS token, the second JWS token and the third JWS token.

Additionally or alternatively, the fourth network node receives, from the third network node, the third HTTPS request, including the security negotiation request message the first JWS token, the second JWS token and the third JWS token. The fourth network node constructs a roaming path based on the first JWS token, the second JWS token, and the third JWS token. The roaming path is a path from the first network node to the second network node, then to the third network node and ending at the fourth network node. Further, the fourth network node accepts the security negotiation request message based on roaming path information corresponding to the roaming path. Also, the fourth network node generates a security negotiation response message. In addition, the fourth network node includes, based on the determination to accept the security negotiation request message, the roaming path information in the security negotiation response message. Further, the fourth network node protects one or more IEs in the security negotiation response message with a fourth JWS token. The fourth JWS token uses a second digital signature and includes a public key certificate of the fourth network node. Moreover, the fourth network node sends over TLS, to the third network node, a first HTTPS response, including the security negotiation response message and the fourth JWS token.

Additionally or alternatively, the third network node receives, from the fourth network node, the first HTTPS response, including the security negotiation response message and the fourth JWS token. Further, the third network node sends over TLS, to the second network node, a second HTTPS response, including the security negotiation response message, the fourth JWS token and a fifth JWS token.

Additionally or alternatively, the second network node receives, from the third network node, the second HTTPS response, including the security negotiation response message, the fourth JWS token and the fifth JWS token. Further, the second network node sends over TLS, to the first network node, a third HTTPS response, including the security negotiation response message, the fourth JWS token, the fifth JWS token, and a sixth JWS token.

Additionally or alternatively, the first network node is a consumer's Security Edge Protection Proxy (SEPP) (CSEPP), the second network node is a first RI Proxy, the third network node is a second RI Proxy, and the fourth network node is a producer's SEPP (pSEPP). Additionally or alternatively, the first network node is a visited PLMN SEPP (vSEPP), and the second network node is a home SEPP (hSEPP).

In another example, a first network node creates a cipher suite negotiation request message. The first network node protects the cipher suite negotiation request message with a first Javascript Object Notation (JSON) Web Signature (JWS) token. Further, the first network node sends, to a second network node, a first HTTPS request, including the cipher suite negotiation request message and the first JWS token.

Additionally or alternatively, the second network node receives. The second network node appends a JWS cipher suit of the second network node to the cipher suite negotiation request message. Further, the second network node protects the JWS cipher suit of the second network node with a second JWS token. Also, the second network node sends, to a third network node, a second HTTPS request, including the cipher suite negotiation request message, the first JWS token and the second JWS token.

Additionally or alternatively, the third network node receives, from the second network node, the second HTTPS request, including the cipher suite negotiation request message, the first JWS token and the second JWS token. The third network node appends a JWS cipher suit of the third network node to the cipher suite negotiation request message. Further, the third network node protects the JWS cipher suit of the third network node with a third JWS token. Moreover, the third network node sends, to a fourth network node, a third HTTPS request, including the cipher suite negotiation request message, the first JWS token, the second JWS token and the third JWS token.

Additionally or alternatively, the fourth network node receives, from the third network node, the third HTTPS request, including the cipher suite negotiation request message, the first JWS token, the second JWS token and the third JWS token. Further, the fourth network node generates a cipher suite exchange response message, including one or more selected cipher suites with the first network node, a separately selected JWS suite for the second network node and the third network node. Also, the fourth network node protects the cipher suite exchange response message with a fourth JWS token. Moreover, the fourth network node sends, to a third network node, a first HTTPS response, including the cipher suite exchange response message and the fourth JWS token.

Additionally or alternatively, the third network node receives, from the fourth network node, the first HTTPS response, including the cipher suite exchange response message and the fourth JWS token. Further, the third network node sends, to the second network node, a second HTTPS response, including the cipher suite exchange response message and the fourth JWS token.

Additionally or alternatively, the second network node receives, from the third network node, the second HTTPS response, including the cipher suite exchange response message and the fourth JWS token. Moreover, the second network node sends, to the first network node, a third HTTPS response, including the cipher suite exchange response message and the fourth JWS token.

Additionally or alternatively, the first network node is a consumer's Security Edge Protection Proxy (SEPP) (CSEPP), the second network node is a first RI Proxy, the third network node is a second RI Proxy, and the fourth network node is a producer's SEPP (pSEPP). Additionally or alternatively, the first network node is a visited PLMN SEPP (vSEPP), and the second network node is a home SEPP (hSEPP).

In another example, a first network node generates Elliptic Curve Diffie-Hellman Key Exchange (ECDHE) keying materials for the first network node, including one or more first information elements for one or more ECDHE groups, and one or more second information elements for one or more ECDHE public values of the first network node. The first network node protects the one or more first information elements and one or more second information elements with a first Javascript Object Notation (JSON) Web Signature (JWS) token. The first JWS token uses a first digital signature. Further, the first network node includes the one or more first information elements and one or more second information elements in a key exchange request message. Moreover, the first network node sends over transport layer security (TLS), to a second network node, a first HTTPS request, including the key exchange request message and the first JWS token.

Additionally or alternatively, the second network node receives, from the first network node, the first HTTPS request, including the key exchange request message and the first JWS token. The second network node sends over TLS, to a third network node, a second HTTPS request, including the key exchange request message and the first JWS token.

The third network node receives, from the second network node, the second HTTPS request, including the key exchange request message and the first JWS token. The network node sends over TLS, to a fourth network node, a third HTTPS request, including the key exchange request message and the first JWS token.

Additionally or alternatively, the fourth network node receives, from the third network node, the third HTTPS request, including the key exchange request message and the first JWS token. The fourth network node generates ECDHE keying materials for the fourth network node, including one or more third information elements for one or more selected ECDHE groups, and one or more fourth information elements for one or more ECDHE public values of the fourth network node. Further, the fourth network node protects the one or more third information elements and one or more fourth information elements with a second JWS token. The second JWS token uses a second digital signature. Also, the fourth network node includes the one or more third information elements and one or more fourth information elements in a key exchange response message. In addition, the fourth network node sends over TLS, to the third network node, a first HTTPS response, including the key exchange response message and the second JWS token. Moreover, the fourth network node derives shared keying materials, including a shared secret, based on the one or more first information elements, the one or more second information elements, the one or more third information elements, and the one or more fourth information elements.

Additionally or alternatively, the third network node receives, from the fourth network node, the first HTTPS response, including the key exchange response message and the second JWS token. The third network node sends over TLS, to the second network node, a second HTTPS response, including the key exchange response message and the second JWS token.

The second network node receives, from the third network node, the second HTTPS response, including the key exchange response message and the second JWS token. Moreover, the second network node sends over TLS, to the first network node, a third HTTPS response, including the key exchange response message and the second JWS token.

Additionally or alternatively, the first network node receives, from the second network node, the third HTTPS response, including the key exchange response message and the second JWS token. Further, the first network node sends, to the fourth network node via the second network node and the third network node, an authentication confirmation message. The first network node derives the shared keying materials, including the shared secret, based on the one or more first information elements, the one or more second information elements, the one or more third information elements, and the one or more fourth information elements. Moreover, the fourth network node receives, from the first network node via the second network node and the third network node, the authentication confirmation message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of a security capability negotiation between Security Edge Protection Proxies (SEPPs);

FIG. 6 illustrates an example of the architecture for PRotocol for N32 INterconnect Security (PRINS);

FIG. 7 illustrates an example of the architecture for PRINS version 2 (v2) with N32-c establishment;

FIG. 8 illustrates an example of the architecture for PRINS v2 N32-c;

FIG. 9 illustrates an example of a key exchange procedure initiated by a consumer's SEPP (CSEPP) in PRINS v2; and

FIG. 10 illustrates an example of a PRINS v2 cipher suite exchange procedure.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A User Equipment (UE) may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

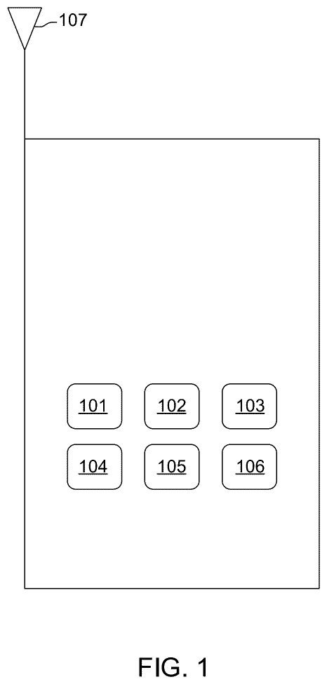

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.).

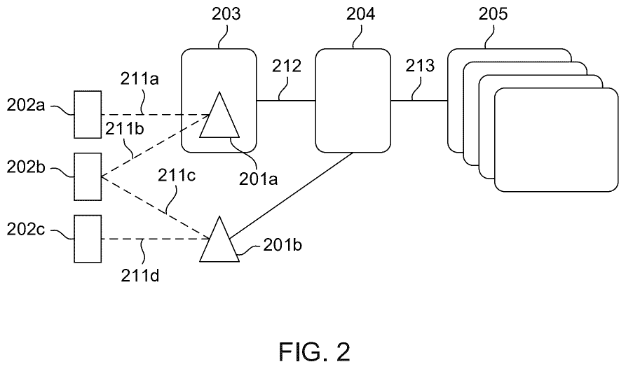

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

A base station may be a network node. Other network nodes may be located in a network, including the core network. A network node may communicate over a wired connection, over a wireless connection, or over both. A network node may include a processor and a communications interface. A network node may be or may include a network function (NF).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMFs, one or more UPFs, one or more Session Management Functions (SMFs), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

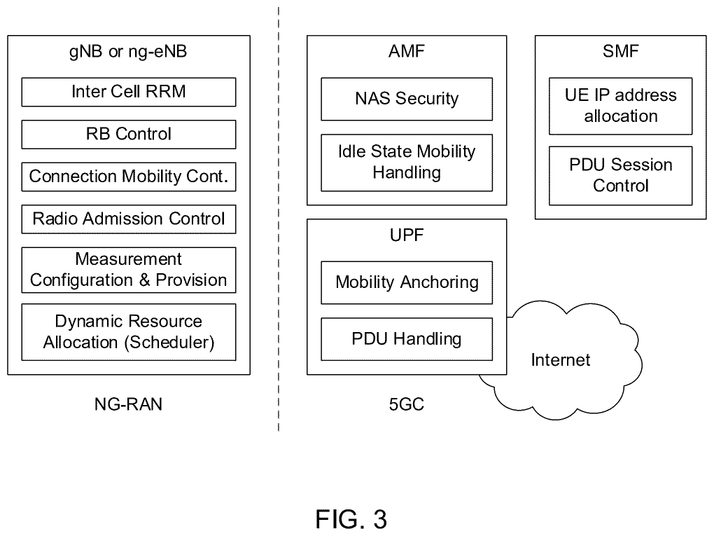

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and Qos, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane Qos, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

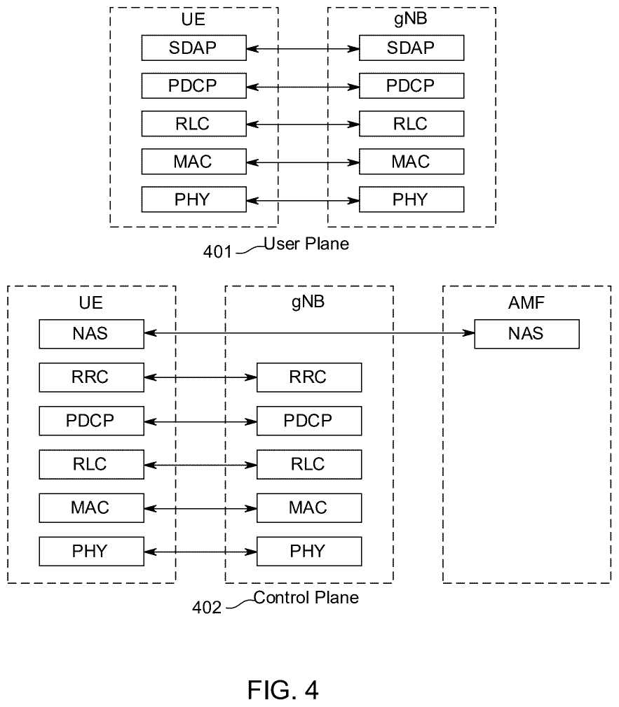

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be 4G, CBRS, cdma2000, 6G, and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

A residential gateway (RG) is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAS), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may be non-3GPP capable, in which case it is referred to as a Fixed Network RG (FN-RG). The 5G-RG may play the role of a UE.

While reference to 5GC is mentioned to assist in explaining the concepts of the embodiments and examples provided herein, these embodiments and examples are equally applicable to other generations of wireless technologies, and may be interchangeable with 3G, 4G, 6G, etc.

There are benefits to both users and operators to allow RGs, and devices that are non-3GPP capable and are behind RGs, to access the 3GPP 5G 5GC. The 5GC provides several features that may be beneficial, independent of the type of access technology used by the devices accessing the network. Users may receive the benefits of the rich 5G features, and operators may have means to charge for the usage of such features.

As an example, there may be one or more procedures that enable access to the Evolved Packet Core (EPC) or the 5GC via non-3GPP RATs. One such example is a UE accessing the 5GC using WLAN.

Additionally, there may be one or more procedures for supporting access to the 5GC via a wireline AN. As an example, a home LAN may be connected to the 5GC via an RG. The RG may contain functionality that enables devices behind it to connect with the 5GC and obtain 5G services.

The 5G-RG and the W-AGF may interface with the 5GC Control Plane (CP) and the 5GC User Plane (UP) functions, via N2 and N3 interfaces, respectively. They may enable authentication, registration and packet data network (PDN) connectivity procedures associated with the devices behind the RG. They may facilitate the provisioning of differentiated services to the devices behind the RG, via the interfaces with the 5GC.

Between two operator networks, Security Edge Protection Proxies (SEPPs) negotiate security capabilities between themselves. A security capability negotiation over the N32-c interface allows the SEPPs to negotiate which security mechanism to use for protecting NF service-related signaling over the N32-f interface. There shall be an agreed security mechanism between a pair of SEPPs before conveying NF service-related signaling over the N32-f interface. A network node may be or may include an SEPP.

When an SEPP notices that it does not have an agreed security mechanism for N32-f interface protection with a peer SEPP or if the security capabilities of the SEPP have been updated, the SEPP shall perform security capability negotiation with the peer SEPP over the N32-c interface in order to determine, which security mechanism to use for protecting NF service-related signaling over the N32-f interface. Certificate based authentication shall follow the profiles previously given, such as in 3GPP TS 33.210, clause 6.2. The contents of 3GPP TS 33.210 are incorporated by reference herein as if fully set forth in their entity.

A mutually authenticated transport layer security (TLS) connection as defined in clause 13.1 of 3GPP TS 33.501 or hypertext transfer protocol secure (HTTPS) and JWS as defined herein shall be used for protecting security capability negotiation over the N32-c interface in examples and embodiments provided herein. The contents of 3GPP TS 33.501 are incorporated by reference herein as if fully set forth in their entity. The TLS connection shall provide integrity, confidentiality and replay protection.

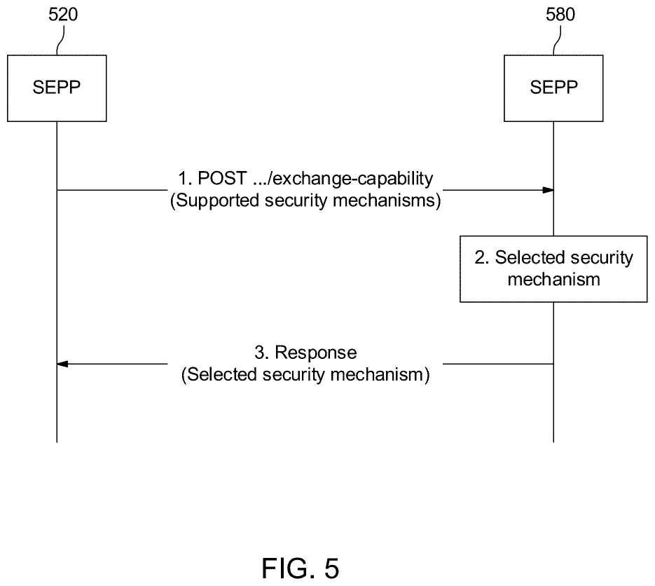

FIG. 5 illustrates an example of a security capability negotiation between Security Edge Protection Proxies (SEPPs). As shown in an example in the first step in FIG. 5, a SEPP 510, which initiated and completed the TLS connection establishment with a SEPP 580, shall issue a POST request to the exchange-capability resource of the responding SEPP 580 including the initiating SEPP's supported security mechanisms for protecting the NF service-related signaling over N32-f (see Table 1, below). The security mechanisms shall be ordered in the initiating SEPP's priority order.

In a second step, the responding SEPP 580 shall compare the received security capabilities to its own supported security capabilities and selects, based on its local policy (for example, based on whether there are roaming intermediary (RI) providers on the path between the SEPPs), a security mechanism, which is supported by both the initiating SEPP 520 and the responding SEPP 580. In a third step, the responding SEPP 580 shall respond to the initiating SEPP 520 with the selected security mechanism for protecting the NF service-related signaling over N32.

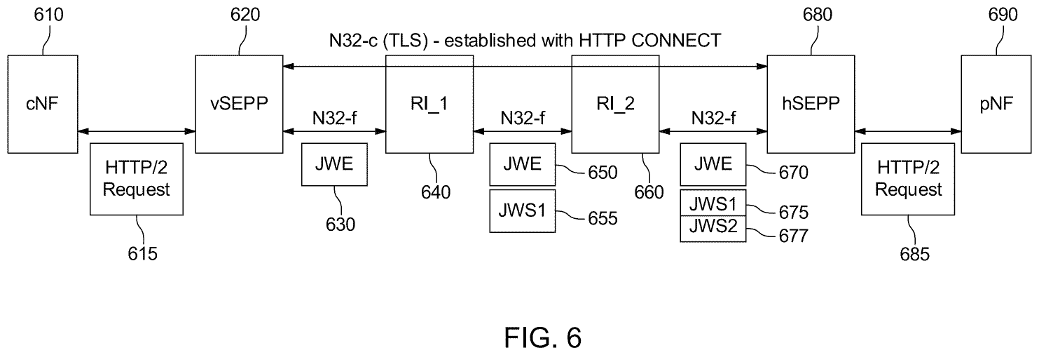

FIG. 6 is illustrates an example of the architecture for PRINS. In an example shown in FIG. 6, PRINS is used for end-to-end signaling security between a visited Security Edge Protection Proxy (SEPP) (vSEPP) 620 in a visited PLMN (vPLMN) and a home SEPP (hSEPP) 680 in a home PLMN (hPLMN). PRINS uses two different protocols for N32. The first protocol is end-to-end TLS for an N32-c connection. Specifically, PRINS uses HTTP CONNECT to establish the end-to-end TLS between vSEPP 620 and hSEPP 680.

The second protocol is end-to-end application layer security for an N32-f connection. The TLS security for the N32-f connection may use Internet Protocol Security (IP Sec), TLS VPN, or both. Signaling messages are protected in the application layer with information elements protected with confidentiality, integrity based on policy, or both.

Within the end-to-end TLS tunnel between vSEPP and hSEPP, one or more of the following N32-c handshake procedures can be executed: the Security Capability Negotiation Procedure (including one or more of: the Parameter Exchange Procedure, the Cipher Suite Negotiation, the Protection Policy Exchange, and the Security Information List); the N32-f Termination Procedure; and the N32-f Error Reporting Procedure. These procedures may be executed as explained in 3GPP TS 29.573. The contents of 3GPP TS 29.573 are incorporated by reference herein as if fully set forth in their entity. After N32-c procedures are completed, the N32-f interface can be initiated to forward NF signaling messages between the vSEPP 620 and hSEPP 680.

In an example shown in FIG. 6, a signaling message may originate in a consumer's NF (cNF) 610 and, accordingly, the cNF 610 may send an HTTP/2 request 615 to the vSEPP 620. In an example, vSEPP 620 may be a consumer's SEPP (cSEPP). Additionally or alternatively, the hSEPP 680 may be a producer's SEPP (pSEPP).

The N32-f/PRINS protects signaling messages in the application layer by reformulating an original HTTP/2 message into a J avaS cript Object Notation (JSON) Web Encryption (JWE) token that is protected for integrity and confidentiality, for example, JWE tokens 630, 650, 670. Protection policies negotiated between the vSEPP 620 and hSEPP 680 (within an end-to-end TLS tunnel) dictates which information elements are protected for confidentiality, and which are modifiable by RIs, such as R1_1 640 and RI_2 660.

RIs can modify the protected] WE token by creating and appending a JSON patch that indicates the desired values of the modifiable information elements in the JWE token. A network node may be or may include an RI. For example, RI_1 640 may create JSON patch JWS 1 655 and append it to JWE token 650. RI_2 660 may forward the JWE and patch as JWE 670 with JWS1 675, and further create and append JWS2 677, as shown in FIG. 6. Those JSON patches, when applied by a receiving SEPP, such as hSEPP 680, would result in a signaling message in the desired states of the RIs 640, 660. Further, hSEPP 680 may validate the JWE 670, JWS1 675 and JWS2 677, and check the modifications against its security policy. If all validations succeed, the pSEPP will recreate the HTTP/2 request message as HTTP/2 request 685. The hSEPP 680 sends the HTTP/2 request 685 to a producer's NF (pNF) 690. A receiving SEPP has a clear understanding of which entities on the signaling path has made what changes to the signaling message, achieving an important security property, namely attributability. Based on the protection policy, particularly the modification policy, a receiving SEPP can decide whether or not to accept a modification by an RI.

PRINS achieves an important objective of end-to-end security (between the vSEPP 620 and hSEPP 680) in the application layer for 5G roaming, while allowing authorized RIs 640, 660 to modify signaling messages as needed, albeit with additional complexity and overhead. PRINS was designed and specified based on the recommendations (application layer security) and requirements (mandatory to implement and use) provided to 3GPP by GSMA.

However, despite achieving this important objective, modifications to PRINS described herein will improve its security and efficiency for all system users. The modifications to PRINS described herein address several problems with the current PRINS N32-c interface, which is an end-to-end TLS tunnel between vSEPP and hSEPP

This end-to-end TLS tunnel provides confidentiality, integrity, and anti-reply protection for N32-c handshake procedures. It can also export keying materials to be used by the symmetric crypto algorithms to protect N32-f/PRINS connection in the application layer.

However, this end-to-end TLS tunnel is problematic from the perspective of RIs in two aspects. First, it requires RIs to support HTTP CONNECT, which introduces both business and security risks to RIs. Second, the confidentiality protection of N32-c procedures appears to impede the operation of RIs.

Supporting HTTP CONNECT, without modification, includes risks. For example, by supporting HTTP CONNECT, RIs allow their HTTP proxies to become TCP proxies between vSEPP and hSEPP, potentially losing visibility and control of what are being transmitted through the TCP tunnel (e.g., when the tunnel is encrypted using TLS). Although legitimate SEPPs would only transmit N32-c handshake procedures within the end-to-end TLS tunnel, any web traffic such as N32-f signaling messages and non-web traffic such as mail traffic can be transmitted within the tunnel. N32-f signaling messages, if sent through the tunnel by untrusted SEPPs, prevent RIs from offing any value added services, resulting in business loss. No-web traffic such as email spams or malware, if transmitted through the tunnel by malicious parties, would result in security risks for the RIs.

Unfortunately, in current, unmodified PRINS, HTTP CONNECT requests are sent over TCP without any cryptographic authentication. Thus, not only a legitimate vSEPP and pSEPP, but any parties with access to the interconnection networks, are able to tunnel through RIs.

A recipient of HTTP CONNECT can only perform access control based on the IP address, which can be spoofed and requires substantial overhead in maintaining the allowed or disallowed IP list. Currently, 3GPP TS 29.573, section 5.5.2, specifies that HTTP CONNECT request shall include the following information in the 3gpp-Connect-Req-Infor header: Connect-purpose= “n32c”; Originating-network-id=vSEPP's PLMN-id; Sender-fqdn=vSEPP's fqdn or RI_1's fqdn; and Intended-n32-purpose=ROAMING). While a recipient may perform access control based on the content in the above header, its content is not cryptographically protected, thus can be spoofed, in current unmodified PRINS.

There appears no easy way for RIs to ensure that only N32-c handshake procedures are being transmitted within the tunnel, since RIs cannot inspect the encrypted tunnel. One mitigation is for RIs to impose a rate limit on the N32-c connection. This is possible, but would introduce configuration overhead for RIs. Even if rate limit on N32-c can be implemented by RIs, it only mitigates concerns on bandwidth usage, it does not provide any assurance that only N32-c procedures are being transmitted within the tunnel. Particularly, RIs cannot prove that their networks are not being misused, for example, to carry out malicious activities.

Without the modifications and example solutions provided herein, the best an RI can do to mitigate the misuse of HTTP CONNECT appears to be access control based on allowed list of IP addresses. This would once again introduce management overhead and impose deployment constraints, but without mitigating risks from misbehaving legitimate SEPPs.

Further, confidentiality protection of N32-c procedures is problematic to RIs since they need to know what are being negotiated between vSEPP and hSEPP to function properly. RIs needs to know what are being negotiated or exchanged between vSEPP and hSEPP.

Specifically, first, RIs need to know what security capability is being negotiated for N32-f to be able to apply their changes properly. Note that HTTP/2 messages sent over N32-f interface are of different formats for TLS and PRINS. If there would be more than one security mechanism between vSEPP and hSEPP, RIs would need to know which security mechanism is being selected. Thus, the confidentiality protection of security capability negotiation procedures is problematic for RIs considering the design objective of future-proofness of the procedure.

Second, the parameter exchange procedure for cipher suite for protecting N32-f/PRINS should also allow an RI to indicate the digitally signing algorithms it supports so that a commonly supported algorithm can be selected by the hSEPP. Otherwise, the hSEPP may not be able to validate an JSON patch created by an RI.

Third, the protection policies being exchanged between vSEPP and hSEPP should be made visible to RIs so they can be inspected and compared with the business contracts the RIs signed with the VPLMN and HPLMN. Otherwise, an RI has no confidence that the exchanged modification policies between vSEPP and hSEPP are correct, or its modifications will be accepted by the vSEPP and hSEPP. Examples provided herein provide solutions to these problems, including problems faced by the RIs.

To summarize, the confidentiality protection of N32-c, provided by the end-to-end TLS tunnel between vSEPP and hSEPP, appears problematic to RIs.

Several changes to PRINS are included in example solutions provided herein to address the above problems. One or more of the examples solutions provided herein apply to currently deployed communications systems, as well newly developed systems, such as Sixth Generation (6G) systems. In an example the changes to PRINS may be included in a new version of PRINS, which may be referred to as PRINS version 2 (PRINS v2). The changes to PRINS include one or a combination of the following.

PRINS v2 does not use HTTP CONNECT to establish an end-to-end TLS connection for N32-c interface. Rather, PRINS v2 uses HTTP scheme ‘https’ to establish TLS in hop-by-hop to protect the transport of N32-c procedures. This eliminates the business and security risks from supporting HTTP CONNECT for RIs.

Further, PRINS v2 uses JSON Web Signature (JWS) to protect the integrity of N32-c handshake procedures. In addition, PRINS v2 does not provide the end-to-end confidentiality of N32-c procedures so that RIs can inspect and participate in the N32-c procedures, e.g., to negotiate security mechanism and cipher suites with vSEPP and hSEPP as needed.

Without the end-to-end TLS for exporting keying materials for protecting N32-f/PRINS, PRINS v2 defines a new N32-c handshake procedure to establish shared keying materials between vSEPP and hSEPP.

PRINS v2 also uses HTTP scheme ‘https’ for protecting the transport of N32-f messages. This creates consistency between the transport protection of both N32-c and N32-f, eliminating ambiguities on certificate validation in N32-f/PRINS. Specifically, N32-c and N32-f can now share a common TLS tunnel that protects both N32-c procedures and N32-f signaling messages.

With those solutions, PRINS v2 harmonizes the operations of SEPPs and RIs for both N32-c and N32-f interfaces, improving its deployability for both operators and RIs. Further detail regarding those solutions is provided herein below.

Table 1 below includes NF service-related signaling traffic protection mechanisms over the N32 interface.

TABLE 1

| N32-f protection mechanism | Description |
|---|---|
| Mechanism 1 | PRINS |
| Mechanism 2 | TLS |
| Mechanism 3 | PRINS version 2 |
| Mechanism n | Reserved |

If the selected security mechanism is PRotocol for N32 INterconnect Security (PRINS), the SEPPs shall behave as specified in clause 13.2 of 3GPP TS 33.501. If the selected security mechanism is PRINS version 2.0, the SEPPs shall behave as described herein below. If the selected security mechanism is PRINS or PRINS version 2 (v2), the SEPP may indicate a security profile.

Further, a security profile can for example include pre-selected cipher suites, default modification policies and default data_type encryption policies and/or a list of information elements (IEs) to be protected, during the N32-c negotiation process.

As introduced above, PRINS v2, is based on PRINS but differs from PRINS in several aspects of N32-c connection.

In PRINS, N32-c is an end-to-end TLS connection between CSEPP and pSEPP over RIs, initiated by using HTTP CONNECT before establishing the TLS connection (for example, per 3GPP TS 29.573 section 5.5.2.1). PRINS v2 does not use HTTP CONNECT to establish end-to-end TLS connection for N32-c. Rather, PRINS v2 uses HTTPS and JWS to protect N32-c communication. In addition, PRINS v2 defines application layer authenticated key exchanges between CSEPP and pSEPP to derive shared keying materials for protecting N32-f communications between CSEPP and pSEPP using JSON Web Encryption (JWE), which may include using procedures as specified in RFC 7516. The contents of RFC 7516 are incorporated by reference herein as if fully set forth in their entity. In this way, the N32-c is based on end-to-end application layer security in PRINS v2.

In this way, PRINS v2 uses hop-by-hop TLS (https) and application layer security (JWE and JWS) for protecting N32-c. Accordingly, the N32-c and N32-f are now fully consistent in terms of transport layer and application layer security. With those changes, PRINS v2 harmonizes the operations of SEP Ps and roaming intermediaries for both N32-c and N32-f interfaces and to allow N32-c and N32-f to share a common TLS tunnel.

To summarize, in PRINS v2, the N32-c procedures are used between the SEPPs in two PLMNs for mutual authentication, security mechanism selection, key exchange, and negotiation of other security configuration parameters. N32-c procedures shall use HTTPS for transport layer protection and JWS/JWE for application layer protection.

The first N32-c procedure to be executed between the SEPPs in two PLMNs shall be the security capability negotiation procedure, further explained below. If the negotiated security protection mechanism is PRINS v2, the key exchange procedure (further explained below) shall be executed next in order to establish the shared keying materials between the two SEP Ps for protecting subsequent communication, including other N32-c procedures and the N32-f interface.

In an example, the key exchange procedure can be combined with the security capability negotiation procedure. For example, an initiating SEPP supporting both PRINS and PRINS v2 can include the key exchange IEs in the security capability negotiation request, and the receiving SEPP supporting PRINS v2 can include the key exchange IEs into the security capability negotiation response. A receiving SEPP supporting only PRINS will ignore the key exchange IEs which it cannot interpret.

The security capability negotiation procedure as defined in 3GPP TS 33.501 section 13.5 and 3GPP TS 29.573 section 5.2.2 applies. In addition, the security capability negotiation request and response shall be protected with JWS. A roaming intermediary can decide whether to allow a security capability negotiation based on the authenticated PLMN IDs either in the TLS certificate or JWS protected request message. A roaming intermediary, if allowing the N32-c connection, shall include its own authenticated identity as a JWS token in the security capability negotiation request. A receiving SEPP can additionally use the authenticated roaming intermediary identities in the security capability negotiation request to decide whether to continue the N32-c negotiation. The receiving SEPP shall include all roaming intermediaries in the security capability negotiation response message. The initiating SEPP can also additionally use the roaming intermediary information in the response message to decide whether to continue N32-c negotiation.

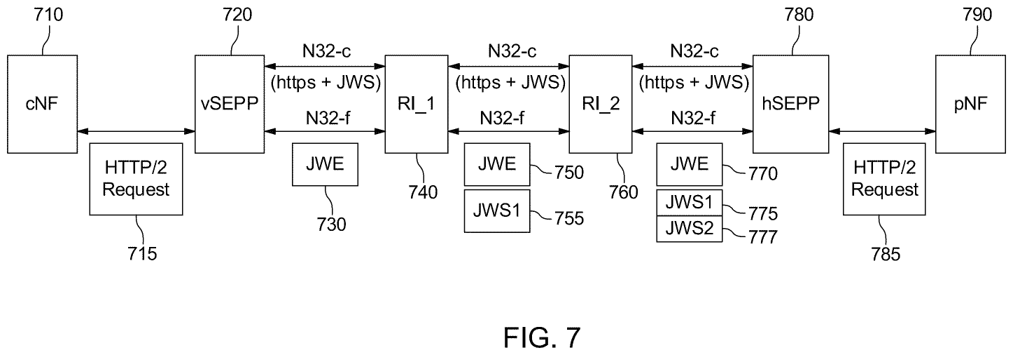

FIG. 7 illustrates an example of the architecture for PRINS v2 with N32-c establishment. In an example shown in FIG. 7, PRINS v2 is used for end-to-end signaling security between a vSEPP 720 in a vPLMN and a hSEPP 780 in an hPLMN. PRINS v2 uses two interfaces (N32-c and N32-f), which are logically separate but can share a common TLS tunnel.

The first protocol is an N32-c connection among the vSEPP 720, the hSEPP 780 and intervening nodes, established hop-by-hop. Specifically, PRINS v2 uses a first HTTPS message appended with a first JWS to establish a first N32-c connection between vSEPP 720 and an RI 1 740. Likewise, PRINS v2 uses a second HTTPS message appended with a second JWS to establish a second N32-c connection between the RI_1 740 and an RI_2 760. Similarly, PRINS v2 uses a third HTTPS message appended with a third JWS to establish a third N32-c connection between the RI_2 760 and the hSEPP 780. In this way, PRINS v2 protects the transport of N32-c communication using TLS hop-by-hop, which can also be used to transport N32-f signaling messages.

The second protocol is end-to-end application layer security for an N32-f connection. Similarly to the examples shown in FIG. 6 above, in examples in FIG. 7, the TLS security for the N32-f connection may use IPsec, TLS VPN, or both. Signaling messages are protected in the application layer with information elements protected with confidentiality, integrity based on policy, or both.

After N32-c procedures are completed, the N32-f interface can be initiated or the N32-c interface is reused to forward NF signaling messages between the vSEPP 720 and hSEPP 780.

In an example shown in FIG. 7, a signaling message may originate in a consumer's NF (cNF) 710 and, accordingly, the cNF 710 may send an HTTP/2 request 715 to the vSEPP 720. In an example, vSEPP 720 may be a consumer's SEPP (cSEPP). Additionally or alternatively, the hSEPP 780 may be a producer's SEPP (pSEPP).

The N32-f/PRINS protects signaling messages in the application layer by reformulating an original HTTP/2 message into a JavaScript Object Notation (JSON) Web Encryption (JWE) token that is protected for integrity and confidentiality, for example, JWE tokens 730, 750, 770. Protection policies negotiated between the vSEPP 720 and hSEPP 780 dictates which information elements are protected for confidentiality, and which are modifiable by RIs, such as the R1 1 740 and RI_2 760.

RIs can modify the protected] WE token by creating and appending a JSON patch that indicates the desired values of the modifiable information elements in the JWE token. A network node may be or may include an RI. For example, RI_1 740 may create JSON patch JWS 1 755 and append it to JWE token 750. RI_2 760 may forward the JWE and patch as JWE 770 with JWS1 775, and further create and append JWS2 777, as shown in FIG. 7. Those JSON patches, when applied by a receiving SEPP, such as hSEPP 780, would result in a signaling message in the desired states of the RIs 740, 760. Further, hSEPP 780 may validate the JWE 770, JWS1 775 and JWS2 777, and check the modifications against its security policy. If all validations succeed, the pSEPP will recreate the HTTP/2 request message as HTTP/2 request 785. The hSEPP 780 sends the HTTP/2 request 785 to a producer's NF (pNF) 790. A receiving SEPP has a clear understanding of which entities on the signaling path has made what changes to the signaling message, achieving an important security property, namely attributability. Based on the protection policy, particularly the modification policy, a receiving SEPP can decide whether or not to accept a modification by an RI. In this way, PRINS v2 eliminates the business and security risks from supporting HTTP CONNECT for RIs 740, 760.

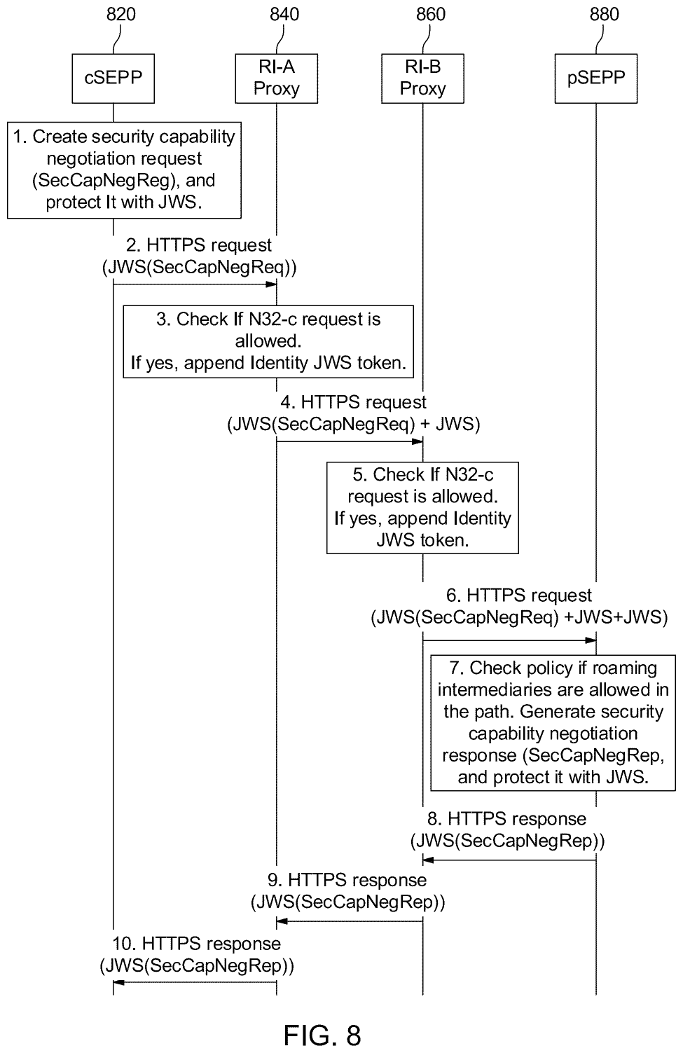

FIG. 8 illustrates an example of a PRINSv2 security capability negotiation procedure. As shown in a first step in an example in FIG. 8, a cSEPP 820 shall use HTTPS as the URI scheme and establish a TLS connection with the RI-A Proxy 840. The CSEPP 820 should include the fully qualified domain name (FQDN) of the RI-A in the security capability negotiation request message. The CSEPP 820 shall protect all IEs in the security capability negotiation request message with JWS using digital signature. The CSEPP's public key certificate shall be included in the JWS token. In this way, the cSEPP 820 creates a security capability negotiation request (SecCapNegReq), and protects it with JWS.

In a second step, the CSEPP 820 shall send the JWS protected security negotiation request message to the RI-A 840 over TLS. In this way, the cSEPP 820 sends the HTTPS request (JWS (SecCapNegReq)) to the RI-A 840.

In a third step, the RI-A 840 checks the security negotiation request message against its security and contractual policies to decide whether to allow this N32 connection negotiation. If it is allowed, the RI-A 840 shall include, or append, the CSEPP PLMN ID and FQDNs of its own and an RI-B Proxy 860 (in order of CSEPP-RI-A-RI-B) as a JWS token in the security negotiation request message.

In a fourth step, the RI-A 840 shall send the JWS protected security negotiation request message to the RI-B 860 over TLS. In this way, the RI-A 840 sends the HTTPS request (JWS (SecCapNegReq)) to the RI-B 860.

In a fifth step, the RI-B 860 checks the security negotiation request message against its security and contractual policies to decide whether to allow this N32 connection negotiation. If it is allowed, the RI-B 860 shall include, or append, the FQDNs of the RI-A 840 and its own and the pSEPP ID (in the order of RI-A-RI-B-pSEPP) as a JWS token in the security negotiation request message.

In a sixth step, the RI-B 860 shall send the JWS protected security negotiation request message to a pSEPP 880 over TLS. In this way, the RI-B 860 sends the HTTPS request (JWS (SecCapNegReq)) to the pSEPP 880.

In a seventh step, the pSEPP 880 shall construct the roaming path (CSEPP-RI-A-RI-B-pSEPP) based on the JWS tokens in the security negotiation request message. The pSEPP 880 can use the roaming path information in deciding whether to accept the security negotiation request message. Accordingly, the pSEPP 880 checks the security negotiation request message against its policy. If accepted, the pSEPP 880 shall include the roaming path information in the security negotiation response message. In this way, the pSEPP 880 generates a security negotiation response (SecCapNegRep). The pSEPP 880 shall protect all IEs in the security capability negotiation response message with JWS using digital signature. The pSEPP's public key certificate shall be included in the JWS token.

In an eighth step, the pSEPP 880 shall send the JWS protected security negotiation response message to the RI-B 860 over TLS. In this way, the pSEPP 880 sends an HTTPS response (JWS (SecCapNegRep)) to the RI-B 860.

In a ninth step, the RI-B 860 shall send the JWS protected security negotiation response message to the RI-A 840 over TLS. In this way, the RI-B 860 sends the HTTPS response (JWS (SecCapNegRep)) to the RI-A 840. Additionally or alternatively, the RI-B 860 sends a fifth JWS token to the RI-A 840. The fifth JWS token may protect one or more information elements that the RI-B 860 may add to the HTTPS response.

In a tenth step, the RI-A 840 shall send the JWS protected security negotiation response message to the CSEPP 820 over TLS. In this way, the RI-A 840 sends the HTTPS response (JWS (SecCapNegRep)) to the CSEPP 820. Additionally or alternatively, the RI-A 840 sends the fifth JWS token to the CSEPP 820. Additionally or alternatively, the RI-A 840 sends a sixth JWS token to the CSEPP 820. Additionally or alternatively, the sixth JWS token may protect one or more information elements that the RI-A 840 may add to the HTTPS response. The CSEPP 820 can use the roaming path information in the security negotiation response message in deciding whether to continue the N32-c negotiation.

In an example, a first network node establishes a transport layer security (TLS) connection with a second network node. The TLS connection is established using hypertext transfer protocol secure (HTTPS) as a uniform resource identifier (URI).

The first network node creates a security negotiation request message, including a fully qualified domain name (FQDN) of the second network node. Further, the first network node protects one or more information elements (IEs) in the security negotiation request message with a first Javascript Object Notation (JSON) Web Signature (JWS) token. The first JWS token uses a first digital signature and includes a public key certificate of the first network node. Moreover, the first network node sends over TLS, to the second network node, a first HTTPS request, including the security negotiation request message and the first JWS token.

Additionally or alternatively, the second network node receives receive, from the first network node, the first HTTPS request, including the security negotiation request message and the first JWS token. Further, the second network node determines to allow an N32 connection negotiation based on checking the security negotiation request message against the security and contractual policies of the second network node. Also, the second network node appends, based on the determination to allow the N32 connection negotiation, a public land mobile network (PLMN) identity (ID) of the first network node, an FQDN of the second network node, and an FQDN of a third network node as a second JWS token to the security negotiation request message. Moreover, the second network node sends over TLS, to the third network node, a second HTTPS request, including the security negotiation request message, the first JWS token and the second JWS token.

Additionally or alternatively, the third network node receives from the second network node, the second HTTPS request, including the security negotiation request message, the first JWS token and the second JWS token. The third network node determines to allow an N32 connection negotiation based on checking the security negotiation request message against the security and contractual policies of the third network node. Further, the third network node appends, based on the determination to allow the N32 connection negotiation, an FQDN of the second network node, the FQDN of the third network node, and a PLMN ID of a fourth network node, as a third JWS token to the security negotiation request message. Moreover, the third network node sends over TLS, to the fourth network node, a third HTTPS request, including the security negotiation request message, the first JWS token, the second JWS token and the third JWS token.

Additionally or alternatively, the fourth network node receives, from the third network node, the third HTTPS request, including the security negotiation request message the first JWS token, the second JWS token and the third JWS token. The fourth network node constructs a roaming path based on the first JWS token, the second JWS token, and the third JWS token. The roaming path is a path from the first network node to the second network node, then to the third network node and ending at the fourth network node. Further, the fourth network node accepts the security negotiation request message based on roaming path information corresponding to the roaming path. Also, the fourth network node generates a security negotiation response message. In addition, the fourth network node includes, based on the determination to accept the security negotiation request message, the roaming path information in the security negotiation response message. Further, the fourth network node protects one or more IEs in the security negotiation response message with a fourth JWS token. The fourth JWS token uses a second digital signature and includes a public key certificate of the fourth network node. Moreover, the fourth network node sends over TLS, to the third network node, a first HTTPS response, including the security negotiation response message and the fourth JWS token.

Additionally or alternatively, the third network node receives, from the fourth network node, the first HTTPS response, including the security negotiation response message and the fourth JWS token. Further, the third network node sends over TLS, to the second network node, a second HTTPS response, including the security negotiation response message, the fourth JWS token and a fifth JWS token.

Additionally or alternatively, the second network node receives, from the third network node, the second HTTPS response, including the security negotiation response message, the fourth JWS token and the fifth JWS token. Further, the second network node sends over TLS, to the first network node, a third HTTPS response, including the security negotiation response message, the fourth JWS token, the fifth JWS token, and a sixth JWS token.

Additionally or alternatively, the first network node is a consumer's Security Edge Protection Proxy (SEPP) (CSEPP), the second network node is a first RI Proxy, the third network node is a second RI Proxy, and the fourth network node is a producer's SEPP (pSEPP). Additionally or alternatively, the first network node is a visited PLMN SEPP (vSEPP), and the second network node is a home SEPP (hSEPP).

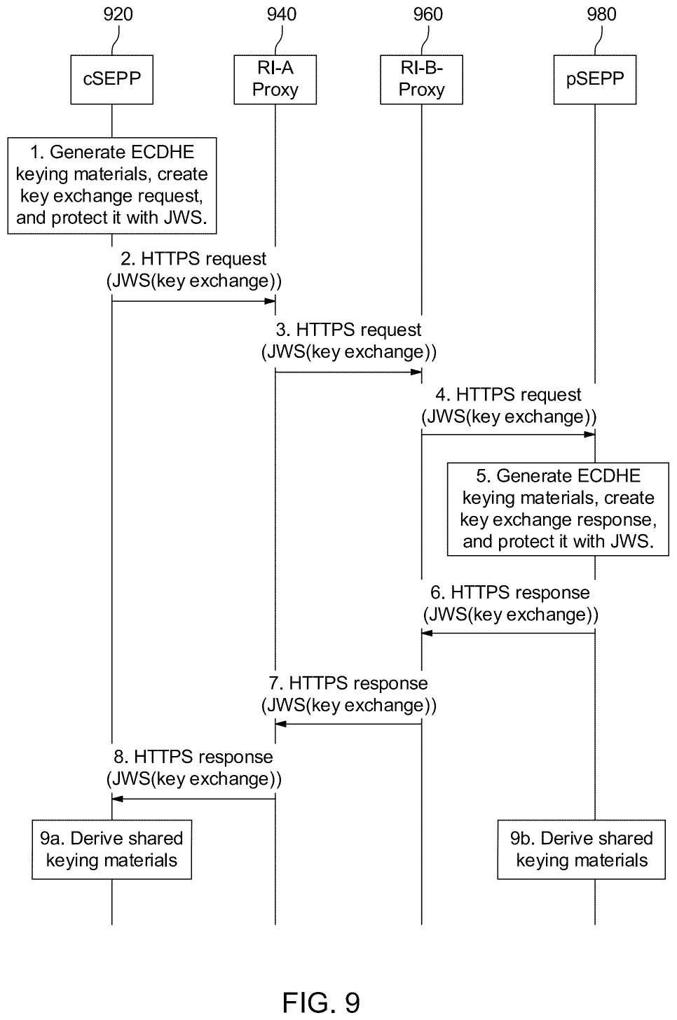

FIG. 9 illustrates an example of a key exchange procedure initiated by a CSEPP. If the negotiated security protection mechanism is PRINS v2 and the key exchange IEs are not included in the security capability negotiation request or response message, a CSEPP 920 shall initiate this key exchange procedure, including one or more steps in the following.

In a first step, the cSEPP 920 shall generate its Elliptic Curve Diffie-Hellman Key Exchange (ECDHE) keying materials. In an example, the keying materials may be generated as explained in section 6 of RFC 7748. The contents of RFC 7748 are incorporated by reference herein as if fully set forth in their entity. Further, the CSEPP 920 shall create a key exchange request. The CSEPP 920 shall protect all IEs (including the ECDHE groups and its ECDHE public values) in the key exchange request message with JWS using digital signature.

In a second step, the cSEPP 920 shall send the JWS protected key exchange request message to an RI-A Proxy 940 over TLS. In this way, the cSEPP 920 sends the HTTPS request (JWS (key exchange)) to the RI-A 940.

In a third step, the RI-A 940 shall send the JWS protected key exchange request message to the RI-B Proxy 960 over TLS. In this way, the RI-A 940 sends the HTTPS request (JWS (key exchange)) to the RI-B 960.

In a fourth step, the RI-B 960 shall send the JWS protected key exchange request message to a pSEPP 980 over TLS. In this way, the RI-B 960 sends the HTTPS request (JWS (key exchange)) to the a pSEPP 980.

In a fifth step, the pSEPP 980 shall generate its ECDHE keying materials. In an example, the keying materials may be generated as explained in section 6 of RFC 7748. Further, the pSEPP 980 shall create a key exchange response. The pSEPP 980 shall protect all IEs (including the selected ECDHE group and its ECDHE public value) in the key exchange response message with JWS using digital signature.

In a sixth step, the pSEPP 980 shall send the JWS protected key exchange response message to an RI-B Proxy 960 over TLS. In this way, the pSEPP 980 sends the HTTPS response (JWS (key exchange)) to the RI-B Proxy 960.

In a seventh step, the RI-B 960 shall send the JWS protected key exchange response message to the RI-A Proxy 940 over TLS. In this way, the RI-B 960 sends the HTTPS response (JWS (key exchange)) to the RI-A Proxy 940.

In an eighth step, the RI-A 940 shall send the JWS protected key exchange response message to the cSEPP 920 over TLS. In this way, the RI-A 940 sends the HTTPS response (JWS (key exchange)) to the CSEPP 920.

After the CSEPP receives the key exchange response in the eighth step, the CSEPP sends back an authentication confirmation message back to pSEPP via RI-A and RI-B. For simplicity, this step is not shown in FIG. 9.

In a ninth step, shown in FIG. 9 as steps 9a and 9b, the cSEPP 920 and pSEPP 980 calculate the shared secret respectively. In an example, the shared secret is calculated as explained in section 5 of RFC 7748. Additionally or alternatively, the calculated shared secret may be used as the N32-f master key. Additionally or alternatively, the calculated shared secret need further derivation before being used as the N32-f master key.

In another example, a first network node generates Elliptic Curve Diffie-Hellman Key Exchange (ECDHE) keying materials for the first network node, including one or more first information elements for one or more ECDHE groups, and one or more second information elements for one or more ECDHE public values of the first network node. The first network node protects the one or more first information elements and one or more second information elements with a first Javascript Object Notation (JSON) Web Signature (JWS) token. The first JWS token uses a first digital signature. Further, the first network node includes the one or more first information elements and one or more second information elements in a key exchange request message. Moreover, the first network node sends over transport layer security (TLS), to a second network node, a first HTTPS request, including the key exchange request message and the first JWS token.

Additionally or alternatively, the second network node receives, from the first network node, the first HTTPS request, including the key exchange request message and the first JWS token. The second network node sends over TLS, to a third network node, a second HTTPS request, including the key exchange request message and the firstj WS token.

The third network node receives, from the second network node, the second HTTPS request, including the key exchange request message and the first JWS token. The network node sends over TLS, to a fourth network node, a third HTTPS request, including the key exchange request message and the first JWS token.

Additionally or alternatively, the fourth network node receives, from the third network node, the third HTTPS request, including the key exchange request message and the first JWS token. The fourth network node generates ECDHE keying materials for the fourth network node, including one or more third information elements for one or more selected ECDHE groups, and one or more fourth information elements for one or more ECDHE public values of the fourth network node. Further, the fourth network node protects the one or more third information elements and one or more fourth information elements with a second JWS token. The second JWS token uses a second digital signature. Also, the fourth network node includes the one or more third information elements and one or more fourth information elements in a key exchange response message. In addition, the fourth network node sends over TLS, to the third network node, a first HTTPS response, including the key exchange response message and the second JWS token. Moreover, the fourth network node derives shared keying materials, including a shared secret, based on the one or more first information elements, the one or more second information elements, the one or more third information elements, and the one or more fourth information elements.

Additionally or alternatively, the third network node receives, from the fourth network node, the first HTTPS response, including the key exchange response message and the second JWS token. The third network node sends over TLS, to the second network node, a second HTTPS response, including the key exchange response message and the second JWS token.

The second network node receives, from the third network node, the second HTTPS response, including the key exchange response message and the second JWS token. Moreover, the second network node sends over TLS, to the first network node, a third HTTPS response, including the key exchange response message and the second JWS token.

Additionally or alternatively, the first network node receives, from the second network node, the third HTTPS response, including the key exchange response message and the second JWS token. Further, the first network node sends, to the fourth network node via the second network node and the third network node, an authentication confirmation message. The first network node derives the shared keying materials, including the shared secret, based on the one or more first information elements, the one or more second information elements, the one or more third information elements, and the one or more fourth information elements. Moreover, the fourth network node receives, from the first network node via the second network node and the third network node, the authentication confirmation message.

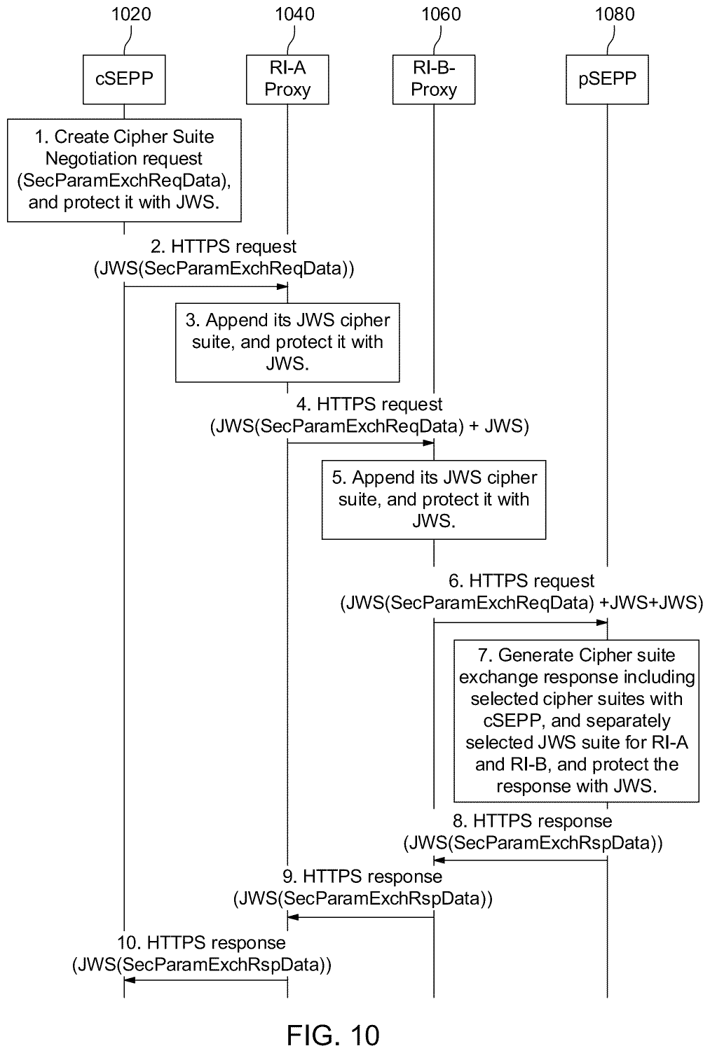

FIG. 10 illustrates an example of a cipher suite exchange procedure. In a first step in an example shown in FIG. 10, a CSEpp 1020 creates a cipher suit negotiation request, including a SecParamExchReqData parameter, and protects the request with JWS using digital signature.

In a second step, the CSEpp 1020 sends the JWS protected SecParamExchReqData in an HTTPS request to an RI-A proxy 1040. In a third step, the RI-A 1040 appends its JWS cipher suite to the JWS protected SecP aramExchReqData, and protects it with a further JWS using digital signature. In a fourth step, the RI-A 1040 sends the JWS protected SecParamExchReqData, further protected by the JWS cipher suite of RI-A 1040, in an HTTPS request to an RI-B Proxy 1060.

In a fifth step, the RI-B 1060 appends its JWS cipher suite to the JWS protected SecParamExchReqData, with protection by the JWS cipher suite of RI-A 1040. In a sixth step, the RI-B 1060 sends the JWS protected SecP aramExchReqData, further protected by the JWS cipher suite of RI-A 1040 and the JWS cipher suite of RI-B 1060, in an HTTPS request to a pSEPP 1080.

In a seventh step, the pSEpp 1080 generates a Cipher suit exchange response, including selected cipher suites with CSEpp 1020, and separately selected JWS suite for RI-A 1040 and RI-B 1060. Further the pSEpp 1080 protects the response with JWS using digital signature. The response may be or may include SecParamExchRspData.

In an eighth step, the pSEpp 1080 the JWS protected SecParamExchRspData in an HTTPS response to the RI-B 1060. Further, the RI-B 1060 sends the JWS protected SecParamExchRspData in an HTTPS response to the RI-A 1040, in a ninth step. Moreover, the RI-A 1040 sends the JWS protected SecParamExchRspData in an HTTPS response to the cSEPP 1020, in a tenth step.

Additionally or alternatively, subsequent N32-c procedures shall be protected with JWS. Additionally or alternatively, subsequent N32-c procedures shall be protected with HTTPS.

In another example, a first network node creates a cipher suite negotiation request message. The first network node protects the cipher suite negotiation request message with a first Javascript Object Notation (JSON) Web Signature (JWS) token. Further, the first network node sends, to a second network node, a first HTTPS request, including the cipher suite negotiation request message and the first JWS token.

Additionally or alternatively, the second network node receives. The second network node appends a JWS cipher suit of the second network node to the cipher suite negotiation request message. Further, the second network node protects the JWS cipher suit of the second network node with a second JWS token. Also, the second network node sends, to a third network node, a second HTTPS request, including the cipher suite negotiation request message, the first JWS token and the second JWS token.

Additionally or alternatively, the third network node receives, from the second network node, the second HTTPS request, including the cipher suite negotiation request message, the first JWS token and the second JWS token. The third network node appends a JWS cipher suit of the third network node to the cipher suite negotiation request message. Further, the third network node protects the JWS cipher suit of the third network node with a third JWS token. Moreover, the third network node sends, to a fourth network node, a third HTTPS request, including the cipher suite negotiation request message, the first JWS token, the second JWS token and the third JWS token.

Additionally or alternatively, the fourth network node receives, from the third network node, the third HTTPS request, including the cipher suite negotiation request message, the first JWS token, the second JWS token and the third JWS token. Further, the fourth network node generates a cipher suite exchange response message, including one or more selected cipher suites with the first network node, a separately selected JWS suite for the second network node and the third network node. Also, the fourth network node protects the cipher suite exchange response message with a fourth JWS token. Moreover, the fourth network node sends, to a third network node, a first HTTPS response, including the cipher suite exchange response message and the fourth JWS token.

Additionally or alternatively, the third network node receives, from the fourth network node, the first HTTPS response, including the cipher suite exchange response message and the fourth JWS token. Further, the third network node sends, to the second network node, a second HTTPS response, including the cipher suite exchange response message and the fourth JWS token.

Additionally or alternatively, the second network node receives, from the third network node, the second HTTPS response, including the cipher suite exchange response message and the fourth JWS token. Moreover, the second network node sends, to the first network node, a third HTTPS response, including the cipher suite exchange response message and the fourth JWS token.

Additionally or alternatively, the first network node is a consumer's Security Edge Protection Proxy (SEPP) (CSEPP), the second network node is a first RI Proxy, the third network node is a second RI Proxy, and the fourth network node is a producer's SEPP (pSEPP). Additionally or alternatively, the first network node is a visited PLMN SEPP (vSEPP), and the second network node is a home SEPP (hSEPP).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A system comprising:
a first network node comprising:
a first processor; and
a first communications interface operatively coupled to the first processor;
wherein:
the first processor and the first communications interface are configured to establish a transport layer security (TLS) connection with a second network node, wherein the TLS connection is established using hypertext transfer protocol secure (HTTPS) as a uniform resource identifier (URI);
the first processor is configured to create a security negotiation request message, including a fully qualified domain name (FQDN) of the second network node;
the first processor is configured to protect one or more information elements (IEs) in the security negotiation request message with a first Javascript Object Notation (JSON) Web Signature (JWS) token, wherein
the first JWS token uses a first digital signature and includes a public key certificate of the first network node; and
the first processor and the first communications interface are configured to send over TLS, to the second network node, a first HTTPS request, including the security negotiation request message and the first JWS token.

2. The system of claim 1, wherein the system further comprises the second network node, wherein the second network node comprises:
a second processor; and
a second communications interface operatively coupled to the second processor; wherein:
the second processor and the second communications interface are configured to receive, from the first network node, the first HTTPS request, including the security negotiation request message and the first JWS token;
the second processor is configured to determine to allow an N32 connection negotiation based on checking the security negotiation request message against security and contractual policies of the second network node;
the second processor is configured to append, based on the determination to allow the N32 connection negotiation, a public land mobile network (PLMN) identity (ID) of the first network node, an FQDN of the second network node, and an FQDN of a third network node as a second JWS token to the security negotiation request message; and
the second processor and the second communications interface are configured to send over TLS, to the third network node, a second HTTPS request, including the security negotiation request message, the first JWS token and the second JWS token.

3. The system of claim 2, wherein the system further comprises the third network node, wherein the third network node comprises:
a third processor; and
a third communications interface operatively coupled to the third processor; wherein:
the third processor and the third communications interface are configured to receive, from the second network node, the second HTTPS request, including the security negotiation request message, the first] WS token and the second JWS token;
the third processor is configured to determine to allow an N32 connection negotiation based on checking the security negotiation request message against security and contractual policies of the third network node;
the third processor is configured to append, based on the determination to allow the N32 connection negotiation, an FQDN of the second network node, the FQDN of the third network node, and a PLMN ID of a fourth network node, as a third JWS token to the security negotiation request message; and
the third processor and the third communications interface are configured to send over TLS, to the fourth network node, a third HTTPS request, including the security negotiation request message, the first JWS token, the second JWS token and the third JWS token.

4. The system of claim 3, wherein the system further comprises the fourth network node, wherein the fourth network node comprises:
a fourth processor; and
a fourth communications interface operatively coupled to the third processor; wherein:
the fourth processor and the fourth communications interface are configured to receive, from the third network node, the third HTTPS request, including the security negotiation request message the first JWS token, the second JWS token and the third JWS token;
the fourth processor is configured to construct a roaming path based on the first JWS token, the second JWS token, and the third JWS token, wherein the roaming path is a path from the first network node to the second network node, then to the third network node and ending at the fourth network node;
the fourth processor is configured to determine to accept the security negotiation request message based on roaming path information corresponding to the roaming path;
the fourth processor is configured to generate a security negotiation response message;
the fourth processor is configured to include, based on the determination to accept the security negotiation request message, the roaming path information in the security negotiation response message;
the fourth processor is configured to protect one or more IEs in the security negotiation response message with a fourth JWS token, wherein the fourth JWS token uses a second digital signature and includes a public key certificate of the fourth network node; and
the fourth processor and the fourth communications interface are configured to send over TLS, to the third network node, a first HTTPS response, including the security negotiation response message and the fourth JWS token.

5. The system of claim 4, wherein in the third network node:
the third processor and the third communications interface are further configured to receive, from the fourth network node, the first HTTPS response, including the security negotiation response message and the fourth JWS token; and
the third processor and the third communications interface are further configured to send over TLS, to the second network node, a second HTTPS response, including the security negotiation response message, the fourth JWS token and a fifth JWS token.

6. The system of claim 5, wherein in the second network node:
the second processor and the second communications interface are further configured to receive, from the third network node, the second HTTPS response, including the security negotiation response message, the fourth JWS token and the fifth JWS token; and
the second processor and the second communications interface are further configured to send over TLS, to the first network node, a third HTTPS response, including the security negotiation response message, the fourth JWS token, the fifth JWS token, and a sixth JWS token.

7. The system of claim 3, wherein the first network node is a consumer's Security Edge Protection Proxy (SEPP) (CSEPP), the second network node is a first RI Proxy, the third network node is a second RI Proxy, and the fourth network node is a producer's SEPP (pSEPP).

8. The system of claim 1, wherein the first network node is a visited PLMN SEPP (vSEPP), and the second network node is a home SEPP (hSEPP).

9. A system comprising:
a first network node comprising:
a first processor; and
a first communications interface operatively coupled to the first processor; wherein:
the first processor is configured to create a cipher suite negotiation request message;
the first processor is configured to protect the cipher suite negotiation request message with a first Javascript Object Notation (JSON) Web Signature (JWS) token; and
the first processor and the first communications interface are configured to send, to a second network node, a first HTTPS request, including the cipher suite negotiation request message and the first JWS token.

10. The system of claim 9, wherein the system further comprises the second network node, wherein the second network node comprises:
a second processor; and
a second communications interface operatively coupled to the second processor; wherein:
the second processor and the second communications interface are configured to receive, from the first network node, the first HTTPS request, including the cipher suite negotiation request message and the first JWS token;
the second processor is configured to append a JWS cipher suit of the second network node to the cipher suite negotiation request message;
the second processor is configured to protect the JWS cipher suit of the second network node with a second JWS token; and
the second processor and the second communications interface are configured to send, to a third network node, a second HTTPS request, including the cipher suite negotiation request message, the first JWS token and the second JWS token.

11. The system of claim 10, wherein the system further comprises the third network node, wherein the third network node comprises:
a third processor; and
a third communications interface operatively coupled to the third processor; wherein:
the third processor and the third communications interface are configured to receive, from the second network node, the second HTTPS request, including the cipher suite negotiation request message, the first JWS token and the second JWS token;
the third processor is configured to append a JWS cipher suit of the third network node to the cipher suite negotiation request message;
the third processor is configured to protect the JWS cipher suit of the third network node with a third JWS token; and
the third processor and the third communications interface are configured to send, to a fourth network node, a third HTTPS request, including the cipher suite negotiation request message, the first JWS token, the second JWS token and the third JWS token.

12. The system of claim 11, wherein the system further comprises the fourth network node, wherein the fourth network node comprises:
a fourth processor; and
a fourth communications interface operatively coupled to the third processor; wherein:
the fourth processor and the fourth communications interface are configured to receive, from the third network node, the third HTTPS request, including the cipher suite negotiation request message, the first JWS token, the second JWS token and the third JWS token;
the fourth processor is configured to generate a cipher suite exchange response message, including one or more selected cipher suites with the first network node, a separately selected JWS suite for the second network node and the third network node;
the fourth processor is configured to protect the cipher suite exchange response message with a fourth JWS token; and
the second processor and the second communications interface are configured to send, to a third network node, a first HTTPS response, including the cipher suite exchange response message and the fourth JWS token.

13. The system of claim 12, wherein:
in the third network node:
the third processor and the third communications interface are further configured to receive, from the fourth network node, the first HTTPS response, including the cipher suite exchange response message and the fourth JWS token; and
the third processor and the third communications interface are further configured to send, to the second network node, a second HTTPS response, including the cipher suite exchange response message and the fourth JWS token; and
in the second network node:
the second processor and the second communications interface are further configured to receive, from the third network node, the second HTTPS response, including the cipher suite exchange response message and the fourth JWS token; and
the second processor and the second communications interface are further configured to send, to the first network node, a third HTTPS response, including the cipher suite exchange response message and the fourth JWS token.

14. The system of claim 11, wherein the first network node is a consumer's Security Edge Protection Proxy (SEPP) (CSEPP), the second network node is a first RI Proxy, the third network node is a second RI Proxy, and the fourth network node is a producer's SEPP (pSEPP).

15. The system of claim 9, wherein the first network node is a visited PLMN SEPP (vSEPP), and the second network node is a home SEPP (hSEPP).

16. A system comprising:
a first network node comprising:
a first processor; and
a first communications interface operatively coupled to the first processor;
wherein:
the first processor is configured to generate Elliptic Curve Diffie-Hellman Key Exchange (ECDHE) keying materials for the first network node, including one or more first information elements for one or more ECDHE groups, and one or more second information elements for one or more ECDHE public values of the first network node;
the first processor is configured to protect the one or more first information elements and one or more second information elements with a first JavaScript Object Notation (JSON) Web Signature (JWS) token, wherein the first JWS token uses a first digital signature;
the first processor is configured to include the one or more first information elements and one or more second information elements in a key exchange request message; and
the first processor and the first communications interface are configured to send over transport layer security (TLS), to a second network node, a first HTTPS request, including the key exchange request message and the first JWS token.

17. The system of claim 16, wherein:
the system further comprises the second network node, wherein the second network node comprises:
a second processor; and
a second communications interface operatively coupled to the second processor; wherein:
the second processor and the second communications interface are configured to receive, from the first network node, the first HTTPS request, including the key exchange request message and the first JWS token; and
the second processor and the second communications interface are configured to send over TLS, to a third network node, a second HTTPS request, including the key exchange request message and the first JWS token; and
the system further comprises the third network node, wherein the third network node comprises:
a third processor; and
a third communications interface operatively coupled to the third processor; wherein:
the third processor and the third communications interface are configured to receive, from the second network node, the second HTTPS request, including the key exchange request message and the first JWS token; and
the third processor and the third communications interface are configured to send over TLS, to a fourth network node, a third HTTPS request, including the key exchange request message and the first JWS token.

18. The system of claim 17, wherein the system further comprises the fourth network node, wherein the fourth network node comprises:
a fourth processor; and
a fourth communications interface operatively coupled to the third processor; wherein:
the fourth processor and the fourth communications interface are configured to receive, from the third network node, the third HTTPS request, including the key exchange request message and the first JWS token;
the fourth processor is configured to generate ECDHE keying materials for the fourth network node, including one or more third information elements for one or more selected ECDHE groups, and one or more fourth information elements for one or more ECDHE public values of the fourth network node;
the fourth processor is configured to protect the one or more third information elements and one or more fourth information elements with a second JWS token, wherein the second JWS token uses a second digital signature;
the fourth processor is configured to include the one or more third information elements and one or more fourth information elements in a key exchange response message;
the fourth processor and the fourth communications interface are configured to send over TLS, to the third network node, a first HTTPS response, including the key exchange response message and the second JWS token; and
the fourth processor is configured to derive shared keying materials, including a shared secret, based on the one or more first information elements, the one or more second information elements, the one or more third information elements, and the one or more fourth information elements.

19. The system of claim 18, wherein:
in the third network node:
the third processor and the third communications interface are further configured to receive, from the fourth network node, the first HTTPS response, including the key exchange response message and the second JWS token; and
the third processor and the third communications interface are further configured to send over TLS, to the second network node, a second HTTPS response, including the key exchange response message and the second JWS token; and
in the second network node:
the second processor and the second communications interface are further configured to receive, from the third network node, the second HTTPS response, including the key exchange response message and the second JWS token; and
the second processor and the second communications interface are further configured to send over TLS, to the first network node, a third HTTPS response, including the key exchange response message and the second JWS token.

20. The system of claim 19, wherein
in the first network node:
the first processor and the first communications interface are further configured to receive, from the second network node, the third HTTPS response, including the key exchange response message and the second JWS token;
the first processor and the first communications interface are further configured to send, to the fourth network node via the second network node and
the third network node, an authentication confirmation message; and
the first processor is further configured to derive the shared keying materials, including the shared secret, based on the one or more first information elements, the one or more second information elements, the one or more third information elements, and the one or more fourth information elements; and
in the fourth network node:
the fourth processor and the fourth communications interface are further configured to receive, from the first network node via the second network node and the third network node, the authentication confirmation message.
